(19) United States
(12) Patent Application Publication
(10) Pub. No.: US 2005/0232308 A1
(43) Pub. Date: Oct. 20, 2005

(54) Frame alignment and cyclic extension partitioning

(75) Inventor: Arthur J. Redfern, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/093,541

(22) Filed: Mar. 30, 2005

Related U.S. Application Data
(60) Provisional application No. 60/563,737, filed on Apr. 19, 2004.

(51) Int. Cl. H04Q 7/00; H04J 3/06

(52) U.S. Cl. 370/503; 370/519

(57) ABSTRACT

A digital subscriber line communication system 10 is provided. The digital subscriber line communication system 10 includes first and second transceivers 12, 14. The first transceiver 12 communicates discrete multitone symbols using frequency division duplexing. The first transceiver 12 is operable to estimate a propagation delay. The second transceiver 14 communicates with the first transceiver 12 and receives the estimated propagation delay from the first transceiver 12. The second transceiver 14 uses the estimated propagation delay to determine a round-trip propagation delay. The second transceiver 14 determines a transmission time advance based at least partially on the round-trip propagation delay.

### CROSS-REFERENCE TO RELATED APPLICATIONS

This application claims priority to U.S. Provisional Application No. 60/563,737 filed Apr. 19, 2004, and entitled “Frame Alignment and Cyclic Extension Partitioning,” by Arthur J. Redfern, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to communication systems, and more particularly, but not by way of limitation, to a system and method for frame alignment and cyclic extension partitioning.

### BACKGROUND OF THE INVENTION

Data communication devices may use various data transmission rates, data encoding formats, and modulation techniques. Two transceivers may cooperate to determine the quality of the communication channel they use to communicate with each other. The two transceivers may also share information to make a collective decision to select operational parameters controlling their communication, for example data transmission rates and data encoding techniques.

In general, data communication takes place in accordance with communication standards which promote interoperability of equipment produced by different manufacturers. As the electronics art advances, the ability to increase data throughput leads to new communication standards supporting higher data transmission rates.

### SUMMARY OF THE INVENTION

According to one embodiment, a digital subscriber line communication system is provided. The system includes first and second transceivers. The first transceiver communicates discrete multitone symbols using frequency division duplexing. The first transceiver is operable to estimate a propagation delay. The second transceiver communicates with the first transceiver and receives the estimated propagation delay from the first transceiver. The second transceiver uses the estimated propagation delay to determine a round-trip propagation delay. The second transceiver determines a transmission time advance based at least partially on the round-trip propagation delay.

A method of distributing echo noise is provided according to one embodiment. The method includes determining, by a first transceiver, an estimate of a first propagation delay from a second transceiver to the first transceiver. The method includes communicating the estimate of the first propagation delay from the first transceiver to the second transceiver. The method includes determining, by the second transceiver, a total propagation delay based at least partially on the estimate of the first propagation delay. The method also includes, advancing a transmission of a discrete multitone symbol transmitted by the first transceiver by a time based on the total propagation delay.

In one embodiment, the preset disclosure provides a device including a transceiver. The transceiver is operable to receive discrete multitone symbols using frequency division duplexing. The transceiver receives a transmission time advance message and transmits discrete multitone symbols using frequency division duplexing advanced in time based on the transmission time advance message. The transmission time advance message is based at least in part on an estimate determined by the transceiver of a propagation delay associated with the received discrete multitone symbols.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram illustrating a first and second transceiver in communication over a channel according to an embodiment of the present disclosure.

FIG. 2 is a diagram of transmitted and received symbols as they relate to frame alignment of an embodiment of the present disclosure.

FIG. 3 is a flow diagram of a method according to an embodiment of the present disclosure.

FIG. 4 is a block diagram of a receiver employing an adjustable processing window according to an embodiment of the present disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

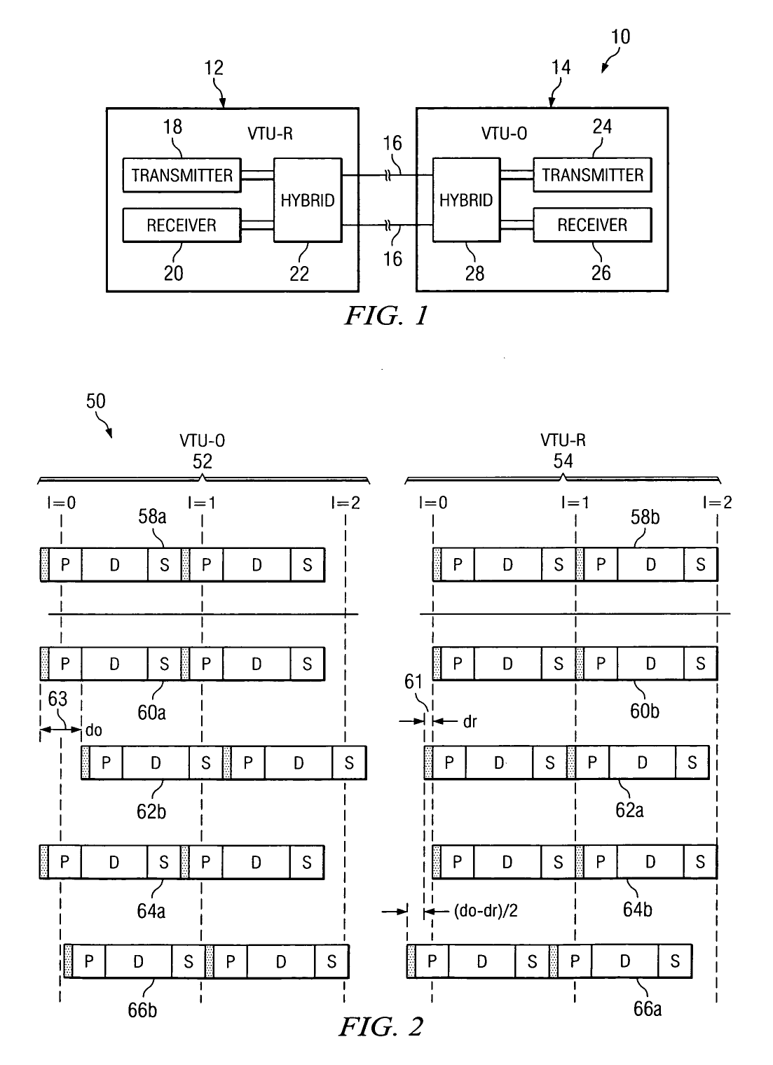

Turning now to FIG. 1, a block diagram depicts a digital subscriber line (DSL) communication system 10. The DSL communication system 10 comprises a first DSL transceiver 12 communicating with a second DSL transceiver 14 over a channel 16. In an embodiment, the channel 16 may comprise an unshielded twisted pair of copper wires. The first DSL transceiver 12 may be located in the home of a DSL subscriber and may be referred to as a VTU-R (video to VDSL terminal unit in the residence). The second DSL transceiver 14 may be located in a central office (CO) operated by a telephone company and may be referred to as a VTU-O (video to very high data rate digital subscriber line [VDSL] terminal unit in the central office). In another embodiment, the first and second DSL transceivers 12, 14 may be located elsewhere. The first DSL transceiver 12 may be referred to as customer premises equipment (CPE). The first DSL transceiver 12 and the second DSL transceiver 14 communicate in accordance with one or more DSL communication standards including asynchronous digital subscriber line (ADSL), very-high-data-rate digital subscriber line (VDSL), or other communication standards.

The first DSL transceiver 12 includes a first transmitter 18, a first receiver 20, and a first hybrid 22. The second DSL transceiver 14 includes a second transmitter 24, a second receiver 26, and a second hybrid 28. The first and second transmitters 18, 24 format data according to the appropriate DSL standard and send the formatted data to the first and second hybrid 22, 28 for transmission on the channel 16. The first and second receivers 20, 26 receive formatted data from the first and second hybrid 22, 28 and decode the data for consumption by other processes (not shown), for example by a higher layer application. The hybrid, for example the first hybrid 22 or the second hybrid 28, is a device well known to those skilled in the art that has the general function of enabling four wire communications, two wires for transmitting and two wires for receiving, to be carried out over only two wires. The first and second transceivers 12, 14 each may be implemented in a single integrated circuit or in two or more integrated circuits coupled to one another. In an embodiment, the first and second hybrids 22, 28 may not be integrated circuits and may be analog components.

The first and second transceivers 12, 14 may coordinate with each other to determine operational parameters to employ to promote communications. The operational parameters may include a frame alignment, a power spectrum density (PSD), and other parameters. The first and second transceivers 12, 14 may share information about these operational parameters during an initialization session prior to engaging in substantive communication. For more information about initialization techniques, refer to U.S. patent application Ser. No. 11/055,377, filed Feb. 10, 2005, entitled “A Flexible Initialization Method for DSL Communication Systems,” by Arthur J. Redfern, which is incorporated herein by reference for all purposes. The transition from initialization to engaging in substantive communication may be referred to as “go to showtime.”

In an embodiment, the first and second DSL transceivers 10, 12 communicate using discrete multitone (DMT) encoding. In DMT encoding, a transmitter, for example the first transceiver 12 acting as a transmitter, may encode a varying number of bits of data into each of a plurality of subchannels that comprise a DMT symbol, transform the DMT symbol from the frequency domain to the time domain using an inverse fast Fourier transform, convert the time domain digital signal to an analog signal, and transmit the analog signal to a receiver, for example the second transceiver 14 acting as a receiver. In addition to subchannels encoding data, the DMT symbol may include a cyclic prefix that duplicates some of the time domain samples to provide redundancy that aids reception of the DMT symbol in a noisy environment or when transmitting over a “long channel,” where long channel refers to the transmission path having a long time domain impulse response.

The transmitter can increase the number of bits encoded on subchannels of the DMT symbol where low noise is present at the receiver. The transmitter may decrease the number of bits encoded on subchannels of the DMT symbol where high noise is present at the receiver to enable the receiver to decode the subchannels. Different subchannels within the DMT symbol may be encoded with different numbers of bits, for example when a first subchannel is associated with a higher level of noise at the receiver than the noise associated with a second subchannel. An example of this is when a narrowband interferer is present in the frequency bandwidth associated with the first subchannel, or because the first subchannel is located at a higher frequency than the second subchannel and the signal-to-noise (SNR) margin in the channel decreases with higher frequency.

Quadrature amplitude modulation (QAM) may be employed to encode bits for subchannels of a DMT symbol. QAM values include a real and an imaginary component. QAM values are discretized and may only take on a limited range of allowed values. The number of QAM values allowed is related to the number of bits which may be encoded using a single QAM value. A small number of allowed QAM values is associated with a small number of bits encoded in a single QAM value; a large number of allowed QAM values is associated with a large number of bits encoded in a single QAM value. The group of allowed QAM values may be referred to as a constellation. A constellation that encodes a large number of bits may be called a high order constellation or a large constellation while a constellation that encodes a small number of bits may be called a low order constellation or a small constellation.

The number of bits to be encoded in each of the subchannels of the DMT symbol, for example the QAM constellation size, may be stored in a bit table or other data structure. The bit table associated with transmissions to the first transceiver 12 may be determined by the first transceiver 12 and communicated to the second transceiver 14 during initialization procedures. The bit table associated with transmissions to the second transceiver 14 may be determined by the second transceiver 14 and communicated to the first transceiver 12 during initialization procedures. In an embodiment, the bit table may be combined with subchannel gain information in a bits and gains table.

The first transceiver 12 may transmit a first DMT symbol to the second transceiver 14 over the channel 16 while receiving a second DMT symbol from the second transceiver 14 over the channel 16, and the second transceiver 14 may receive the first DMT symbol over the channel 16 while transmitting the second DMT symbol over the channel. The first DMT symbol encodes energy in a first group of subchannels or frequency bands that the second DMT symbol encodes with zero or negligible energy, and the second DMT symbol encodes energy in a second group of subchannels that the first DMT symbol encodes with zero or negligible energy. This method of duplexing is referred to as frequency division duplexing.

When the transceivers 12, 14 transmit, some of the transmission energy may be echoed back to the transceivers 12, 14. Echoed transmission energy may bleed from one band of subchannels over into another band of subchannels, for example from the first group of subchannels into the second group of subchannels, and may interfere with decoding subchannel QAM characters. This interference may be modeled and referred to as echo noise. If the echoed transmit symbol, for example the first DMT symbol, is synchronized in time with the received symbol, for example the second DMT symbol, the echo noise is said to be orthogonalized or substantially orthogonalized, and may be readily discriminated from the received symbol, for example the second DMT symbol. When the echoed transmit symbol is not synchronized in time, the echo noise is less orthogonalized and interferes with receiving the received symbol, for example the second DMT symbol. Generally, due to propagation delays in the channel 16, transceivers 12, 14 may not both have synchronized transmit and received symbols. In an embodiment, depending on the length of the cyclic extension and the channel length, it may be possible that both transceivers 12, 14 may both have synchronized transmit and received symbols.

Turning now to FIG. 2, a segment 50 of a communication session between the first transceiver 12 and the second transceiver 14 is depicted. The view the second transceiver 14, or the VTU-O, takes of the segment 50 is depicted by a VTU-O session 52, while the view the first transceiver 12, or the VTU-R, takes of the segment 50 is depicted by a VTU-R session 54. The time references t=0, t=1, and t=2 are used to align symbol pairs which are transmitted by the transmitter and receiver at substantially the same time. Displacement vertically down through the segment 50 is associated with symbol pairs transmitted later in time.

The second transceiver 14 transmits a first symbol 58, depicted in the VTU-O session 52 as a first transmitted symbol 58a, before time t=0. The first transceiver 12 received the first symbol 58, depicted in the VTU-R session 54 as a first received symbol 58b, at time t=0. The first transceiver 12 is able to estimate the channel delay based on the first received symbol 58b, for example by analyzing a known content of the first symbol 58 to infer properties of the channel 16 including the channel propagation delay.

At a later time, the second transceiver 14 transmits a second symbol 60, depicted in the VTU-O session 52 as a second transmitted symbol 60a, before time t=0. The first transceiver 12 receives the second symbol 60, depicted in the VTU-R session 54 as a second received symbol 60b at time t=0. The delay between the time the second transceiver 14 transmits the second symbol 60 and the first transceiver 12 receives the second symbol 60 is a channel propagation delay.

The first transceiver 12 concurrently transmits a third symbol 62, depicted in the VTU-R session 54 as a third transmitted symbol 62a, before time t=0, advanced by a time offset (dr) 61 corresponding to the channel propagation delay estimated by the first transceiver 12. If the offset is such that the received data portion D of a received symbol, for example the third received symbol 62b, overlaps with only one transmit symbol, for example the second transmitted symbol 60b, then the echo is orthogonal to the received subchannels. This offset increases the echo noise experienced by the first transceiver 12, because the echo from the third transmitted symbol 62a is not synchronized with the second received symbol 60b. The greater the time offset (dr) 61, the greater the echo noise experienced by the first transceiver 12. The first transceiver 12 communicates the time offset (dr) 61 to the second transceiver 14 in the third symbol 62. The second transceiver 14 receives the third symbol 62, depicted in the VTU-O session 52 as a third received symbol 62b at a time after time t=0. The offset between the time the second transmitted symbol 60a is transmitted by the second transceiver 14 and the time the third received symbol 62b is received by the second transceiver 14 may be represented by (do) 63. If the value of (do) 63 becomes large enough that the received data portion D of the received symbol overlaps more than one transmit symbol, the echo is not orthogonal to the received subchannels and the echo noise experienced at the second transceiver 14 is increased.

The second transceiver 14 is able to determine the total two-way channel propagation delay in the channel 16 based on the value of the time offset (dr) 61 communicated in the third symbol 62 and based on the known time offset of the first and second transmitted symbols 58a and 60a. While this process is depicted in FIG. 2 as completing in only a few symbols, in an embodiment additional symbols may be exchanged between the transceivers 12, 14 to finish exchanging the value of (dr) and to finish determining the two-way channel propagation delay. This two-way channel propagation delay may be determined as (do) 63+(dr) 61. The second transceiver 14, being a VTU-O which may be located in a central office, may align concurrent transmission of symbols to multiple transceivers that are VTU-Rs located in separate and distinct homes. In an embodiment, the second transceiver 14 requests the first transceiver 12 to transmit using a time shift to reduce the echo noise experienced by the second transceiver 14. This may be referred to as frame alignment.

Various frame alignments may be employed including a fair frame alignment and a biased frame alignment. The several frame alignments may be referred to as distributing echo noise or distributions of echo noise between the first and second transceivers 12, 14. In fair frame alignment, the first transceiver 12 transmits using a time shift such that the time offset experienced by the second transceiver 14 between transmitted and received symbols is equal to the time offset experienced by the first transceiver 12 between transmitted and received symbols. In fair frame alignment, the first transceiver 12 advances transmission of a symbol by a time (do+dr)/2 relative to the reception of a symbol. Expressed alternately, when the first transceiver 12 has already advanced transmission of a symbol by a time (dr) 61 relative to the reception of a symbol, for example during an initialization procedure, the first transceiver 12 may further advance transmission of a symbol by a time (do−dr)/2 relative to the standing advance of (dr) 61 to achieve fair frame alignment. This frame alignment is illustrated in FIG. 2 where the second transceiver 14 transmits a fourth symbol 64, and the first transceiver 12 transmits a fifth symbol 66 advanced by the time (do−dr)/2 relative to the prior advance of (dr) 61 employed when transmitting the third transmitted symbol 62a.

When both the second transceiver 14 and the first transceiver 12 are equally affected by echo noise, fair frame alignment permits both the transceivers 12, 14 to share in the alignment equally, which may reduce echo orthogonalization in the event the transceivers 12, 14 use different data transmission rates because of band plans or other noise. In some circumstances, however, the data rate needs of the transceivers 12, 14 may not be equal. For example, in some circumstances more data may flow from the second transceiver 14 to the first transceiver 12, and it may be more desirable for the second transceiver 14 to transmit using a higher data rate. In this case, it may be desirable to distribute more of the echo noise to the second transceiver 14, leading to the first transceiver 12 transmitting DMT symbols with subchannels encoded with lower order QAM constellations, so that the second transceiver 14 can transmit DMT symbols with subchannels encoded with higher order QAM constellations and hence at a higher data rate to the first transceiver 12. If one of the transceivers 12, 14 is more affected by the echo noise, it may be desirable to distribute more of the echo noise to the other transceiver 12, 14. This kind of unequal frame alignment may be referred to as biased frame alignment.

Biased frame alignment may be accomplished by the first transceiver 12 advancing symbol transmission by an amount k(do−dr) where k is a biasing factor in the range from 0 to 1. When k is 0, all of the echo noise is distributed to the second transceiver 14, and when k is 1, all of the echo noise is distributed to the first transceiver 12. When k is ½, the echo noise is disturbed according to fair frame alignment, as discussed above. For values of k from 0 to less than ½, more of the echo noise is distributed to the second transceiver 14. For values of k from ½ to 1, more of the echo noise is distributed to the first transceiver 12. In an embodiment, the first and second transceivers 12, 14 may conduct an initialization session during which biased frame alignment is negotiated between the first and second transceivers 12, 14.

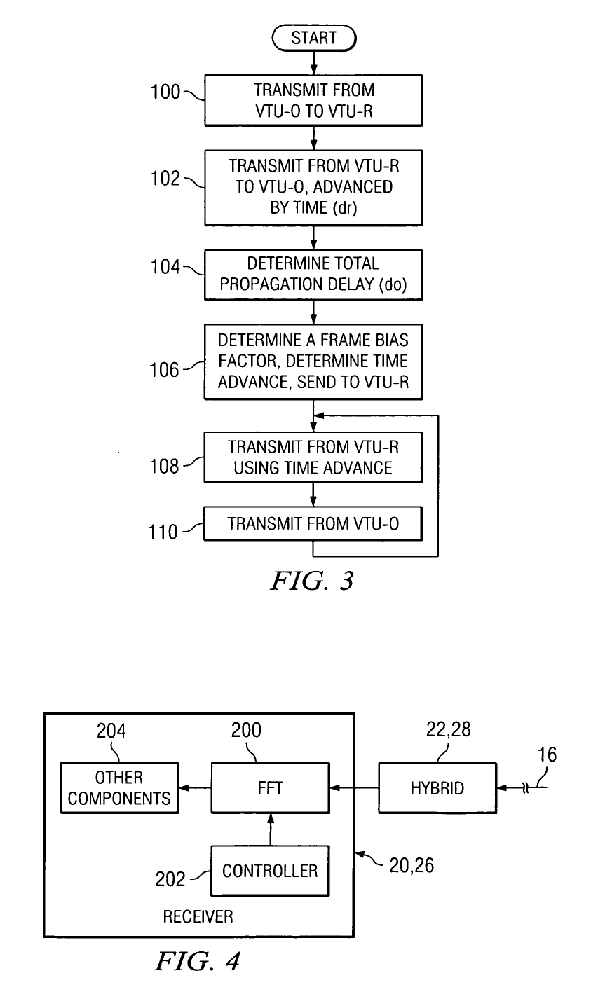

Turning now to FIG. 3, a method of performing frame alignment is depicted. In block 100, the second transceiver 14 transmits to the first transceiver 12. The method proceeds to block 102 where the first transceiver 12 estimates a first propagation delay (dr) of transmissions from the second transceiver 14 to the first transceiver 12. The first transceiver 12 transmits to the second transceiver 14, using a time advance based on the estimate of the first propagation delay (dr). The first transceiver 12 includes the value of the estimate of the first propagation delay (dr) in the transmission.

The method proceeds to block 104 where the second transceiver 14 receives the transmission from the first transceiver 12. The second transceiver 14 is able to determine the total propagation delay (do) based on the sequence of transmissions and the estimated first propagation delay (dr). The method proceeds to block 10 where the second transceiver 14 determines a frame advance factor having a value between 0 and 1 and determines a time advance by multiplying the total propagation delay (do) by the frame advance factor. If the frame advance factor is 0.5, fair frame alignment is employed. If the frame advance factor is not 0.5, the frame alignment is biased one way or another. The second transceiver 14 transmits the time advance to the first transceiver 12. The second transceiver 14 may transmit the time advance to the first transceiver 12 in a transmission time advance message.

The method proceeds to block 108 where the first transceiver 12 transmits using the time advance. The method proceeds to block 110 where the second transceiver 14 transmits. The method returns to block 108 to loop continuously for the duration of the communication session. While the diagram may suggest sequential transmissions, in the preferred embodiment the first and second transceivers 12, 14 transmit substantially concurrently. In an embodiment, the method may provide for readjusting the time advance according to a different bias or frame alignment.

Frame alignment generally may be accomplished during initialization procedures. In an embodiment, the first and second transceivers 12, 14 may modify frame alignment at some point after initialization procedures have been completed, for example during a maintenance communication session initiated by one of the transceivers 12, 14. As the received symbol shifts in time relative to the framing time, the transceiver 12, 14 may adjust a processing window that is used to transform the data portion of the symbol from the time domain to the frequency domain so that the subchannels can be isolated and decoded.

Turning now to FIG. 4, a receiver, such as receivers 20, 26 shown in FIG. 1, is illustrated in communication with the hybrid 22, 28 is depicted. The receiver 20, 26 comprises a fast Fourier transformer component 200, a controller 202 operable to adjust the fast Fourier transformer (FFT) component 200, and other receiver components 204. The FFT component 200 transforms a selected or windowed portion of the symbol into the frequency domain and feeds this frequency domain signal to the other receiver components 204 which may equalize and demodulate the QAM characters to form a digital data stream for use by upper layer processes. Other components may exist between the FFT component 200 and the hybrid 22, 28, for example serial to parallel converters and analog to digital converters. The controller 202 is operable to select the portion or window of the symbol that the FFT component 200 operates upon. In one embodiment, the controller 202 may shift the window of the symbol that the FFT component 200 operates upon based on the time shift associated with frame alignment processes.

This shifting of the processing window relies upon the circular property of the cyclic prefix and cyclic suffix. The bits forming the cyclic prefix are taken from the end of the data portion symbol and bits forming the cyclic suffix are taken from the beginning of the data portion of the symbol. Shifting the processing window is an adjustment accomplished at the receiver. An alternative to shifting the processing window involves reallocating redundancy between the cyclic prefix and cyclic suffix, which may be referred to cyclic extension partitioning. In cyclic extension partitioning, the transmitter adds additional cyclic prefix bits and decreases cyclic suffix bits or decreases cyclic prefix bits and increases cyclic suffix bits to accomplish the effect of shifting the processing window at the receiver.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

1. A digital subscriber line communication system, comprising:
a first transceiver operable to communicate discrete multitone symbols using frequency division duplexing, the first transceiver further operable to estimate a propagation delay; and
a second transceiver operable to communicate with the first transceiver and receive the estimated propagation delay from the first transceiver, the second transceiver using the estimated propagation delay to determine a round-trip propagation delay, the second transceiver further operable to determine a transmission time advance based at least partially on the round-trip propagation delay.

2. The system of claim 1, wherein the second transceiver determines the transmission time advance to distribute an echo noise desirably between the first and the second transceiver, the echo noise associated with a misalignment between received symbols and transmitted symbols.

3. The system of claim 2, wherein the second transceiver determines the transmission time advance to distribute more of the echo noise to the first transceiver than to the second transceiver.

4. The system of claim 2, wherein the second transceiver determines the transmission time advance to distribute less of the echo noise to the first transceiver than to the second transceiver.

5. The system of claim 2, wherein the second transceiver determines the transmission time advance to distribute substantially equal portions of the echo noise to the first transceiver and to the second transceiver.

6. The system of claim 2, wherein the second transceiver determines the transmission time advance at least partly based on an initialization negotiation with the first transceiver.

7. The system of claim 1, wherein the first and second transceiver communicate in accordance with a very high data rate digital subscriber line protocol using frequency division duplexing.

8. The system of claim 1, wherein the second transceiver determines a first propagation delay of a first discrete multitone symbol from the first transceiver to the second transceiver based at least in part on the estimated propagation delay and a second propagation delay of a second discrete multitone symbol from the second transceiver to the first transceiver based at least in part on the estimated propagation delay and the transmission time advance is based on the sum of the first and second propagation delay.

9. A method of distributing echo noise, comprising:
determining, by a first transceiver, an estimate of a first propagation delay from a second transceiver to the first transceiver;
communicating the estimate of the first propagation delay from the first transceiver to the second transceiver;
determining, by the second transceiver, a total propagation delay based at least partially on the estimate of the first propagation delay; and
advancing a transmission of a discrete multitone symbol transmitted by the first transceiver by a time based on the total propagation delay.

10. The method of claim 9, wherein the first transceiver and the second transceiver communicate in accordance with a very high data rate digital subscriber line protocol using frequency division duplexing.

11. The method of claim 9, wherein the time is determined as the total propagation delay divided by two, whereby the echo noise is distributed substantially equally between the first transceiver and the second transceiver.

12. The method of claim 9, wherein the time is determined as the total propagation delay multiplied by a factor in the range from greater than zero to less than one-half, whereby the echo noise is distributed relatively more to the first transceiver than to the second transceiver.

13. The method of claim 9, wherein the time is determined as the total propagation delay multiplied by a factor in the range from greater than one-half to one, whereby the echo noise is distributed relatively more to the second transceiver than to the first transceiver.

14. A device, comprising:
a transceiver operable to receive discrete multitone symbols using frequency division duplexing, the transceiver further operable to receive a transmission time advance message and to transmit discrete multitone symbols using frequency division duplexing advanced in time based on the transmission time advance message, the transmission time advance message based at least in part on an estimate determined by the transceiver of a propagation delay associated with the received discrete multitone symbols.

15. The device of claim 14, wherein the transceiver includes a receiver portion comprising:
a discrete Fourier transformer component operable to transform a portion of a discrete multitone symbol to the frequency domain, wherein the discrete multitone symbol includes a cyclic prefix, a data portion, and a cyclic suffix; and
a controller in communication with the discrete Fourier transformer component and operable to adjust the portion of the discrete multitone symbol.

16. The device of claim 14, wherein the controller adjusts the portion of the discrete multitone symbol responsive to a time shift of the discrete multitone symbol relative to a framing time interval.

17. The device of claim 14, wherein the transceiver communicates according to a very high data rate digital subscriber line communication protocol.

18. The device of claim 14, wherein the transmission time advance distributes a portion of an echo noise to the transceiver.

19. The device of claim 14, wherein the transceiver negotiates the transmission time advance at least partly based on an initialization session.

20. The device of claim 19, wherein the echo noise distribution is further defined as a biased distribution.
